(19) United States
(12) Patent Application Publication
(10) Pub. No.: US 2008/0170812 A1
(43) Pub. Date: Jul. 17, 2008

(54) Image composition processing method, computer system with image composition processing function

(75) Inventors: Kuo Hsiang SUN, Taipei (TW); Chin Yuan Teng, Taipei (TW); Hsiu Ling Chiu, Taipei (TW); Wen-Shiu Hsu, Taipei (TW)

Correspondence Address: QUINTERO LAW OFFICE, PC, 2210 MAIN STREET, SUITE 200, SANTA MONICA, CA, 90405, US

(73) Assignee: ASUSTEK COMPUTER INC., Taipei City (TW)

(21) Appl. No.: 12/014,064

(22) Filed: Jan. 14, 2008

(30) Foreign Application Priority Data
Jan. 17, 2007 (TW) TW96101726

(51) Int. Cl. G06K 9/54

(52) U.S. Cl. 382/305

(57) ABSTRACT

An image composition processing method is disclosed. The image composition processing method includes the steps of obtaining a template from a template database, producing a background in the image displaying area according to the template, wherein the image displaying area has at least a photo reserved area, obtaining a object image from an image capture device, executing an image processing on the object image, and depicting the object image to the photo reserved area after the image processing is finished.

### BACKGROUND OF THE INVENTION

1. Field of the Invention

The invention relates to an image processing method and, more particularly, to a image composition processing method and a computer system with an image composition processing function.

2. Description of the Related Art

Photo sticker machine is an image processing device which combines functions of photographing, portraying, drawing, image composition, and high resolution printing. Users select background and take photos, and then, the photos can be printed after being mixed by special effect processing.

However, the photo sticker machine is of big volume and very heavy, so that users cannot take photo stickers at home. Nowadays, most of household computers (such as desktop computers or notebooks) have a built-in webcam or are externally connected with a webcam, and the webcam can be used to receive images and sound from other sides of internet or capture personal images as a camera. If the webcam and the household computer can be combined to provide functions of the photo sticker machine, users can enjoy more entertainment when they use household computers.

Therefore, the invention provides an image composition processing method and a computer system with an image composition processing function to enable users to take photo stickers by personal computer system (such as desktop computers or notebooks).

### BRIEF SUMMARY OF THE INVENTION

To obtain the above objectives and other objectives, an embodiment of the invention discloses an image composition processing method, which includes the steps of obtaining a template from a template database, producing a background in an image displaying area according to the template, wherein the image displaying area has at least a photo reserved area, obtaining a object image from a image capture device, executing an image processing on the object image, and depicting the processed image to the photo reserved area.

The embodiment of the invention further discloses a computer system an image composition processing function, and the computer system includes a background producing module, an image capture device, a storage medium, and an image processing module. The background producing module depicts a background in an image displaying area according to an obtained template, wherein the image displaying area has at least a photo reserved area. The image capture device is used to obtain an object image. The storage medium is used to store the object image. The image processing module is used to execute an image processing on the object image obtained from the storage medium and to depict the processed image to the photo reserved area.

### BRIEF DESCRIPTION OF THE DRAWINGS

FIG. 1 is a schematic diagram showing the architecture of a computer system with a function of image composition processing in one embodiment of the invention.

FIG. 2 is a flowchart showing the steps of the image composition processing method in one embodiment of the invention.

FIG. 3 shows an image displaying area.

### DETAILED DESCRIPTION OF THE EMBODIMENTS

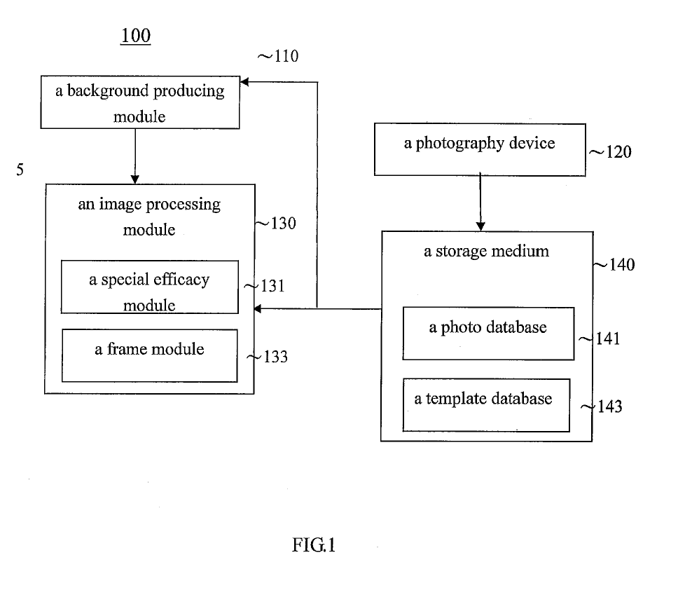

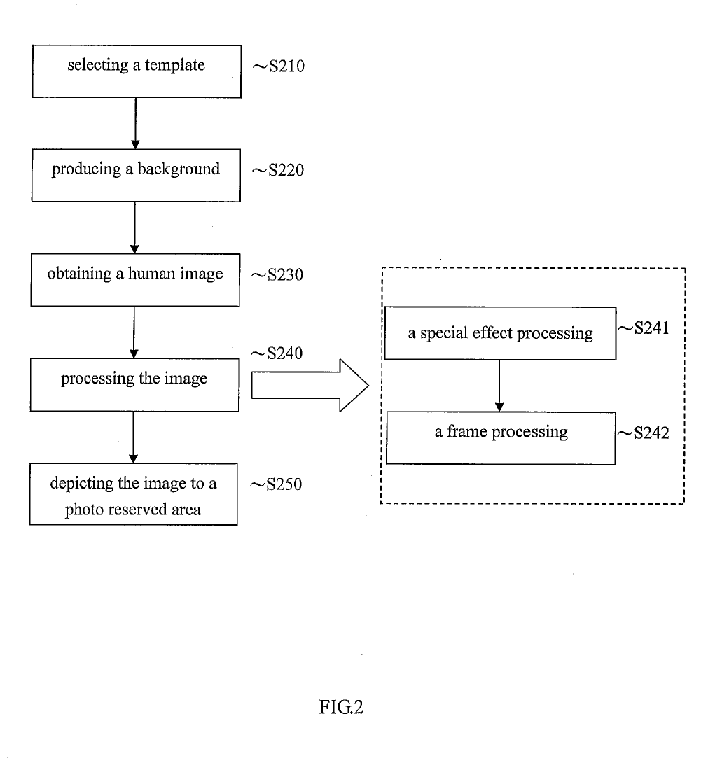

These and other features, aspects, and advantages of the present invention will become better understood with regard to the following description of embodiments, FIG. 1, and FIG. 2. The specification of the invention provides different embodiments to disclose technique features of different implementing manners, wherein the configuration of the elements in the embodiments is just for explanation but not for limitation. Moreover, the repeated reference numbers in the drawings of the embodiments are just for a concise purpose, and do not mean any relevance of different embodiments.

Embodiments of the invention disclose an image composition processing method and a computer system with an image composition processing function.

FIG. 1 is a schematic diagram showing the architecture of a computer system with an image composition processing function in one embodiment of the invention.

Computer system 100 includes a background producing module 110, an image capture device 120, an image processing module 130, and a storage medium 140. In the embodiment, the computer system 100 is preferred to be a portable computer system such as a notebook computer, a tablet personal computer (PC), a palmtops, or an Ultra Mobile PC (UMPC). In other embodiments, the computer system 100 also can be a desktop computer, a bare bone system, or a server.

In the embodiment, functions of the background producing module 110 and the image processing module 130 can be implemented via hardware or software. If functions of the background producing module 110 and the image processing module 130 are implemented via hardware, the background producing module 110 is respectively coupled to the image processing module 130 and the storage medium 140, the image capture device 120 is coupled to the storage medium 140, and the image processing module 130 is coupled to the storage medium 140. The background producing module 110 and the image processing module 130 can be integrated into an image processing chip or can be achieved by at least an application specific integrated circuit (ASIC), respectively.

If functions of the background producing module 110 and the image processing module 130 are implemented via software, the background producing module 110 and the image processing module 130 can be a part of application programs stored in the computer system 100.

The image capture device 120 can be a webcam for photographing and capturing object images, such as human images, and it can be built-in or externally connected with the computer system 100. The storage medium 140 further includes a photo database 141 and a template database 143, and the photo database is used to store the photos captured by the photography apparatus 120. The background producing module 110 depicts a background in the image displaying area (not shown) according to a template obtained from the template database 143, wherein the image displaying area includes at least a photo reserved area.

The image processing module 130 further includes a special effect module 131 and a frame module 133. The special effect module 131 is used to execute a special effect processing on the image obtained from the photo database 141. The frame module 133 is used to execute a frame processing on the image (for example, add a special effect frame to the edge of the photo reserved area where the photo is placed). The photo reserved area, the processed photo, and the selected frame are synthesized an output image.

FIG. 2 is a flowchart showing the steps of the image composition processing method in one embodiment of the invention.

First, a template is obtained from a template database (step S210), and a background is produced in an image displaying area according to the template, wherein the image displaying area has at least a photo reserved area (step S220). After that, an object image is obtained from a photography apparatus (such as a webcam) (step S230), and an image processing is executed on the object image (step S240). The steps of the image processing includes utilizing a special effect module to execute a special effect processing on the object image (step S241) and utilizing a frame module to execute a frame processing on the object image (step S243). For example, a transparency processing is executed on the element added to the image, a rotating processing is executed on the photo reserved area, and a special effect frame is added to the edge of the photo reserved area. After all, the processed photo is depicted to the photo reserved area (step S250).

In step S241, detailed description of the special effect processing is as follows. Generally speaking, binary array data can be extracted from the image picture of the object image to be processed. A 640×480 picture can be viewed as a 640×480 array, every pixel of the array data includes information of three colors, red (R), green (G), and blue (B), and every color occupies a byte. That is, color of one pixel is represented by information of three bytes, and special effect processing is often to make modification according to the content of this pixel or other pixels. For example, values of G and B of every pixel are set to be 0, and only the original value of R is retained, and then the produced picture can only show red color, and brightness is reduced. The following are common image special effect processing.

Blurring is to change color information of every pixel to the average value of color of the original pixel and adjacent pixel. That is, R, G, B values of the following nine points, top-left, top, top-right, centre (the original reference point), right, bottom-left, bottom, bottom-right are added together, and then the sum is divided by nine (if the point is on the edge or in a corner, they can be averaged according to the situation) to replace the original color information. Since the color of every pixel in the whole picture will become close to the color value of the adjacent pixel, a blurring effect can be produced.

Negative is to do XOR logic operation between the values of R, G, and B in the color information of every pixel and 0xFF. If the original value of R is 100, the new value is 255−100=155. Therefore, the color information of the whole picture will become absolutely opposite to the original color information, and a negative effect can be produced.

Mosaic is to take a grid with fixed size as a unit of a picture, to calculate average value of R, G, B values of all pixels in the unit, and to replace the R, G, B values of all pixels in the unit with the average value. Taking a 640×480 picture as an example, if a 4×4 grid is processed to have a mosaic effect, the picture is divided into 160×120 regions first, and the average R, G, B value of every region is calculated to replace the R, G, B value of all pixels. Because color value of every grid after being calculated is the same and close to the color value of the original picture, mosaic effect is produced.

As shown in FIG. 3, the image displaying area includes three photo reserved areas, wherein the frame represents the photo reserved area, and the photo represents the shot object image. The top-left photo reserved area is processed by frame processing, and the object image thereof is processed by negative. The top-right photo reserved area is processed by folding processing and postmarking. The bottom photo reserved area is added a plurality of objects which are processed by transparency processing.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An image composition processing method suitable for executing on a computer, the method comprising the steps of:
obtaining a template from a template database;
producing a background in an image displaying area according to the template, wherein the image displaying area has at least a photo reserved area;
obtaining an object image from an image capture device;
executing an image processing on the object image; and
depicting the processed object image to the photo reserved area after the image processing is finished.

2. The image composition processing method according to claim 1, wherein the image processing further comprises the steps of:
executing a special effect processing on the object image via a special effect module; and
executing a frame processing on the photo reserved area via a frame module.

3. A computer system with an image composition processing function, the computer system comprising:
a background producing module, which is used to depict a background in an image displaying area according to a selected template, wherein the image displaying area has at least a photo reserved area;
an image capture device for obtaining an object image;
a storage medium coupled to the background producing module and the photography apparatus, wherein the storage medium is used to store the object image; and
an image processing module coupled to the background producing module and the storage medium, wherein the image processing module is used to execute an image processing on the object image obtained from the storage medium and to depict the object image to the photo reserved area after the image processing is finished.

4. The computer system according to claim 3, wherein the storage medium further comprises:
a photo database for storing the object image obtained by the image capture device; and
a template database for storing the template.

5. The computer system according to claim 3, wherein the image processing module further comprises:
a special effect module for executing a special effect processing on the object image; and
a frame module for executing a frame processing on the object image.
